(19) United States
(12) Patent Application Publication
(10) Pub. No.: US 2006/0289098 A1
(43) Pub. Date: Dec. 28, 2006

(54) Tire containing cellular rubber within its tire cavity

(76) Inventors: George Frank Balogh, North Canton, OH (US); Thomas Joseph Segatta, Copley, OH (US); Brian Ernest McMahon, Akron, OH (US); Maurice Jacob Frank, North Canton, OH (US); Leonard James Reiter, Norton, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/159,953

(22) Filed: Jun. 23, 2005

(51) Int. Cl. B29D 30/04; B60C 7/00

(52) U.S. Cl. 152/310; 156/112; 156/123; 156/79

(57) ABSTRACT

The present invention relates to the preparation of a tire (e.g. open torroidal shaped tire) which contains a closed cell cellular rubber within its tire cavity. In one aspect, the cellular rubber is a closed cell cellular rubber composition prepared with an organic peroxide curative with closed cell forming blowing agent. In one aspect, the tire may contain the closed cell cellular rubber under pressure within its tire cavity. In another aspect, the closed cell cellular rubber is formed with a heat profile for the rubber tire casing by utilization of a balance between an organoperoxide and blowing agent to cause a cooperative combination of curing and closed cellular formation of the rubber composition within the tire casing cavity.

### FIELD OF THE INVENTION

The present invention relates to the preparation of a tire (e.g. open torroidal shaped tire) which contains a closed cell cellular rubber within its tire cavity. In one aspect, the cellular rubber is a closed cell cellular rubber composition prepared with an organic peroxide curative with closed cell forming blowing agent. In one aspect, the tire may contain the closed cell cellular rubber under pressure within its tire cavity. In another aspect, the closed cell cellular rubber is formed with a heat profile for the rubber tire casing by utilization of a balance between an organoperoxide and blowing agent to cause a cooperative combination of curing and closed cellular formation of the rubber composition within the tire casing cavity.

### BACKGROUND OF THE INVENTION

A challenge is presented to prepare a pneumatic tire which contains closed cell cellular rubber within its tire cavity by effectively foaming and curing a rubber composition within the tire cavity with a more efficient use of the organoperoxide to thereby result in less resultant unreacted organoperoxide together with a faster cure time and resultant controlled (reduced) heat profile for the tire casing itself.

Such challenge includes both suitably combining the rate of peroxide curing of the uncured rubber composition within the rubber tire cavity under conditions of activating temperature with the rate of closed cell formation by the chemical blowing agent in the rubber composition before it is fully cured by the organoperoxide, all with a view toward causing most of the organoperoxide to react within a limited duration of time in order for only a minimal amount of unreacted organoperoxide to remain.

In practice, a pneumatic tire which contains a closed cell rubber within its tire cavity such tire may be conventionally prepared, for example, by fitting an uncured rubber composition within the cavity of an already cured a pneumatic rubber tire followed by foaming and curing the uncured rubber composition within the tire cavity itself under conditions of activating temperature by use of a combination of dicumyl peroxide as the organoperoxide to decompose and form free radical peroxide and a chemical blowing agent to decompose to form a gaseous and a resultant closed cell formation.

It is considered herein that simply replacing the dicumyl peroxide with another organoperoxide to form a peroxide free radical upon its decomposition would for such procedure would not be a simple matter without experimentation with the result being uncertain without such experimentation particularly since, for example, a too high or too low of a rate of organoperoxide decomposition and resultant curing of the rubber composition may cause the chemical blowing agent to not be able to suitably form the cellular structure by making the cellular structure it too dense or insufficiently dense to be effective and the possibility exists for a more than minimal amount of organoperoxide may remain within the closed cellular foam rubber composition in the tire cavity.

In practice, various tires have historically been suggested which contain foamed material within their tire cavities. For example, see U.S. Pat. Nos. 3,022,810, 3,381,735, 3,650,865, 3,872,201, 4,060,578 and 6,623,580 of which U.S. Pat. No. 3,650,865 is informative as to methodology of preparation of a tire containing a tire inflating foam material within its tire cavity under pressure.

In practice, such tires have been suggested, for example, and as illustrated in U.S. Pat. Nos. 3,650,865 and 6,623,580, by inserting layers of a blowing agent-containing rubber composition within the cured tire cavity. The tire is then mounted on a rim to form an assembly thereof and the assembly heated to cause the layers of rubber composition to expand and cure as the blowing agent is heat activated.

In the description of this invention, the term “phr” where used herein, and according to conventional practice, refers to “parts of a respective material per 100 parts by weight of rubber, or elastomer”. The terms “rubber” and “elastomer” where used herein, may be used interchangeably, unless otherwise indicated. The terms “rubber composition”, “compounded rubber” and “rubber compound”, may be used interchangeably, unless otherwise indicated, to refer to “rubber which has been blended or mixed with various ingredients and materials” and such terms are well known to those having skill in the rubber mixing or rubber compounding art. The term “carbon black” as used herein means “carbon blacks having properties typically used in the reinforcement of elastomers, particularly peroxide or sulfur-curable elastomers, namely, rubber reinforcing carbon black”. A reference to an elastomer's Tg refers to its glass transition temperature which can conveniently be determined by a differential scanning calorimeter at a heating rate of 10° C. per minute.

### SUMMARY AND PRACTICE OF THE INVENTION

In accordance with one aspect of this invention, a method of producing a tire which contains a closed cellular rubber within its cavity comprises heating an assembly comprised of a vulcanized (toroidally shaped) tire and an uncured, unfoamed rubber insert contained within its tire cavity to cause said rubber insert to both cure and expand to form a closed cell containing rubber within the tire cavity:

wherein said uncured, unfoamed, rubber insert is comprised of:

(A) at least one conjugated diene-based elastomer comprised of, based upon parts by weight per hundred parts by weight rubber (phr):
(1) cis 1,4-polyisoprene rubber (synthetic and/or natural, preferably synthetic, cis 1,4-polyisoprene rubber), or
(2) about 25 to about 100, alternately about 25 to about 95, phr of cis 1,4-polyisoprene rubber, (synthetic and/or natural, preferably synthetic, cis 1,4-polyisoprene rubber), and from zero to about 75, alternately from about 5 to about 75, phr of at least one additional conjugated diene-based rubber;

(B) heat activatable, (free radical generating, e.g. decompositional free radical peroxide generating), organoperoxide having a one hour half life temperature in a range of from about 70° C. to about 150° C., and

(C) heat activatable, (gas generating, e.g. decompositional gas generating), blowing agent having a heat activatable temperature within a range of from about 80° C. to about 150° C.

In further accordance with this invention said unfoamed rubber insert contains from about 10 to about 60 phr of carbon black.

In additional accordance with this invention said carbon black is comprised of rubber reinforcing carbon black.

In further accordance with this invention said carbon black is comprised of a combination of rubber reinforcing carbon black and coal dust. Such combination may be, for example, from about 0.1 to about 75 weight percent coal dust, based upon the total of rubber reinforcing carbon black and coal dust.

Representative of various rubber reinforcing carbon blacks can easily be found in The Vanderbilt Rubber Handbook, 1978 edition, Page 417.

Coal dust is carbonaceous dust from naturally occurring coal. It might sometimes be referred to as being coal fines. Coal dust is of significantly greater size than rubber reinforcing carbon black.

The term “one hour half life temperature” for the organoperoxide, as referred to herein, means the temperature at which the amount of undecomposed peroxide (e.g. undecomposed to a free radical) in the rubber composition is reduced to one half of its original amount in the rubber composition. For example, if the concentration of the organoperoxide in a rubber composition is 7 phr, then its one hour half life temperature is the temperature at which the concentration of the organoperoxide which has not become decomposed in the rubber composition is reduced to 3.5 phr after a period of one hour.

The “one hour half life temperature” for the organoperoxide is considered herein to be important in a sense that it is a measure of rate of organoperoxide decomposition and thus indicative of a reduced cure times for the peroxide curable rubber composition and indicative of a reduced time for and a more complete peroxide decomposition (e.g. said decompositional free radical peroxide generation). Thus a lower one half life temperature is indicative of a faster reacting organoperoxide, (e.g. faster decompositional free radical peroxide generation).

The term “heat activatable temperature” for the blowing agent, as referred to herein, means a temperature range in which the blowing agent significantly decomposes to form a gas which, in turn, forms a closed cell structure within the rubber composition. For example, if the blowing agent begins to significantly decompose within a short period of time to form the gas at or about, or even below, a threshold temperature of about 80° C., and continues to so decompose, most likely at a higher rate of decomposition, as the temperature of the rubber composition increases, such as for example to about 150° C., then the “heat activatable temperature” for the blowing agent might be said to be about 80° C. to about 150° C.

The “heat activatable temperature” for the blowing agent is considered herein to be important in a sense that it is desired that the decomposition of the blowing agent is largely completed (e.g. at least 90 percent, and preferably about 100 percent, completed) within the said one hour half life of the organoperoxide to thereby aid in both reducing the heat history of the already cured rubber tire carcass and, also to effectively form the foamed rubber insert within the confines of the rate of curing of the foamed rubber via the organoperoxide decomposition.

A significant aspect of this invention is the preparation of a foamed cis-1,4-polyisoprene rubber rich rubber insert within a pre-cured rubber tire in a manner to better control the heat profile for the rubber tire by selection of a combination of organoperoxide and blowing agent with suitable and compatible one hour half life temperatures so that the pre-cured rubber tire is exposed to the elevated closed cell forming temperature of the insert within the cavity of the pre-cured rubber tire. It is considered herein if an optimal balance of one hour half life temperature of the organoperoxide and decomposition temperature range of the blowing agent is not suitably reached, then a significant risk of excessively curing of the rubber insert prior to a suitable extent of internal closed foam formation or, in the alternative, of insufficiently curing of the rubber insert subsequent to the internal closed cell foam formation within the rubber insert.

In further accordance with this invention, a cured rubber tire/rigid rim assembly is provided, wherein said cured rubber tire is of an open toroidal shape, having a cavity defined by said toroidal rubber tire and said rigid rim, wherein said cavity contains an unfoamed rubber insert therein,

wherein said uncured, unfoamed, rubber insert is comprised of:

(A) at least one conjugated diene-based elastomer comprised of, based upon parts by weight per hundred parts by weight rubber (phr):
(1) cis 1,4-polyisoprene rubber, or
(2) about 20 to about 100, alternately about 25 to about 90, phr of cis 1,4-polyisoprene rubber, and from zero to about 75, alternately about 5 to about 75, phr of at least one additional conjugated diene-based rubber;

(B) heat activatable, free radical generating, organoperoxide having a one hour half life temperature in a range of from about 70° C. to about 150° C., and

(C) heat activatable, gas generating, blowing agent having a heat activatable temperature within a range of from about 80° C. to about 150° C.

As hereinbefore discussed, and in further accordance with this invention, said uncured rubber insert within said tire cavity contains from about 10 to about 60 phr of carbon black. Said carbon black may be comprised of a rubber reinforcing carbon black. Said carbon black may be comprised of a combination of rubber reinforcing carbon black and coal dust. Such combination may be, for example, from about 0.1 to about 75 weight percent coal dust, based upon the total of rubber reinforcing carbon black and coal dust.

In one aspect, said cured rubber tire/rigid rim assembly is provided wherein said uncured rubber insert within said tire cavity is composed of a plurality of layers of the uncured rubber composition as a foamable foam rubber precursor within the tire cavity of the cured rubber tire.

In a further aspect of the invention, said cured rubber tire/rigid rim assembly is provided wherein the uncured rubber insert is composed of individual strips of the uncured rubber composition and/or a spirally wound strip of the uncured rubber composition or a combination thereof.

In further accordance with this invention, a cured rubber tire/rim assembly is provided wherein said cured rubber tire is of an open toroidal shape, having a cavity defined by toroidal rubber tire and said rigid rim, wherein said cavity contains a closed cellular foamed rubber insert therein prepared by said method.

As hereinbefore discussed, in further accordance with this invention, said closed cellular foamed rubber insert contains from about 10 to about 60 phr of carbon black. Said carbon black may be a rubber reinforcing carbon black. Said carbon black may be a combination of rubber reinforcing carbon black and coal dust. Such combination may be, for example, from about 0.1 to about 75 weight percent coal dust, based upon the total of rubber reinforcing carbon black and coal dust.

In practice, representative of said organoperoxides are, for example, n-Butyl 4,4-di(tert-butylperoxy) valerate having a one hour half life temperature of about 130° C. and 1,1′-di-(tert-butyl peroxy)-3,3,5-trimethyl cyclohexane having a one hour half life temperature of about 117° C.

In practice, representative of said blowing agent having a decomposition temperature within a range of from about 80° C. about 150° C. is, for example, benzene sulfonyl hydrazide.

In practice, said uncured rubber insert within said tire cavity is desirably composed of a plurality of layers of the uncured rubber composition as a foamable foam rubber precursor within the tire cavity of the previously vulcanized rubber tire.

The plurality of the uncured rubber composition may be composed of individual strips of the uncured rubber composition and/or a spirally wound strip of the uncured rubber composition of a combination thereof.

In additional accordance with this invention, said method provides a method of inflating a tire with foamable rubber material which comprises:

(A) layering at least one pre-formed strip of said unfoamed, foamable rubber in an abutting annular relation within the cavity of a said previously cured tire to thereby form a laminated annular insert which, when foamed, expands within the tire cavity and produces a tire pressure within the tire cavity;

(B) mounting the tire with said laminated annular insert therein on a rigid rim to form a tire/insert/rim assembly thereof, and

(C) heating the said tire/insert/rim assembly to a temperature in a range of from about 100° C., alternately about 135° C., to about 150° C. to foam and cure the foamable material therein to form a closed cell foamed rubber insert under pressure within the tire/rim cavity.

In practice, the thickness of each uncured rubber strip for said insert is preferably in a range of from about 0.508 cm (about 0.2 inch) to about 2.54 cm (about 1 inch) thick.

In practice, the method may include the step of compacting the layers of unfoamed, foamable, rubber radially against each other and the inner crown of the tire prior to mounting the tire on a rim.

In practice, the method of said compacting may include mounting an air bag adjacent to one of said layered strips of unfoamed, foamed rubber and inflating the air bag to compressively engage said layer and exert an outwardly directed radial force thereagainst.

In practice, the process of layering includes the step of placing the first strip of unfoamed, foamable rubber against the inner crown of the tire.

In practice, the method includes swabbing the inner crown of the tire with an adhesive prior to placing the first strip of unfoamed, foamable rubber thereagainst.

### BRIEF DESCRIPTION OF THE DRAWINGS

The accompanying Drawings include a side view of a tire with portions cut away to illustrate the layering of unfoamed, foamable strips of rubber within the tire cavity as well as a cross sectional view of a tire with closed cellular rubber formed from said unfoamed strips filling its cavity.

### THE DRAWING

In the Drawing, a tire (1) is provided having a tire cavity (2) and crown region surface (3).

In the tire cavity (2) is placed a plurality of unfoamed, foamable strips (4) in an annular fashion, with the first strip (4A) being placed against the surface of the crown (3) of the tire within its tire cavity (2) to which an adhesive has been applied for increasing the adhesion of the first layer (4A) of the strips (4) against the crown region surface (3).

Accordingly, successive layers of the strips (4) are placed within the tire cavity to form a built-up unfoamed, foamable, insert (6) comprised of a plurality of laminates of the strips (4) in annular planes which are concentric and generally parallel to the annular planes of the tire tread (6) and inside crown region surface (3) of the tire (1). The width (W) of the strips (4) somewhat approximates the width of the portion of the tire cavity (2) in which they are placed.

The layers of the strips (4) are disposed within the tire cavity (2) in a successively smaller coiled relationship.

Alternately a continuous strip (4) of unfoamed, foamable rubber is spirally disposed within the tire cavity (2).

The quantity of foamable material in the form of the strip (4) is related to the density of the material, the blowing agent content, the choice of blowing agent and the amount of strip material inserted within the tire cavity (2).

The successive layers of the strip (4) are generally substantially equal in thickness and width and, if more material is needed, a separate compensator strip (not shown) may be optionally placed around the inner periphery of the innermost layer to enhance the uniformity of the insert (5) within the tire cavity (2).

If desired, an air bag (not shown) may be mounted within the tire cavity (2) which can be inflated to compact or compress the insert (5) of layers of the strip (4) against each other and tire (1) as well as the sides of the tire cavity (2), wherein the air bag is removed after such compacting of the insert (5) within the tire cavity (2).

Alternately, for a relatively wide tire (1) the strips (4), or at least a portion of the strips (4), can be placed in a side-by-side relation within the tire cavity (2).

The insert (5) containing tire (1) is then mounted on a rigid rim (not shown) to enclose the tire cavity (2) to form a tire/insert/rim assembly (not shown).

The tire/insert/rim assembly is placed in an autoclave (not shown) and the tire/insert/rim assembly heated therein from room temperature (e.g. about 23° C.) to a temperature in a range of from about 100° C. to about 150° C. to activate the blowing agent (begin and continue its decomposition and associated gas formation at the temperature increases) internally within the strips and to thereby create a closed foam pressurized cellular rubber structure.

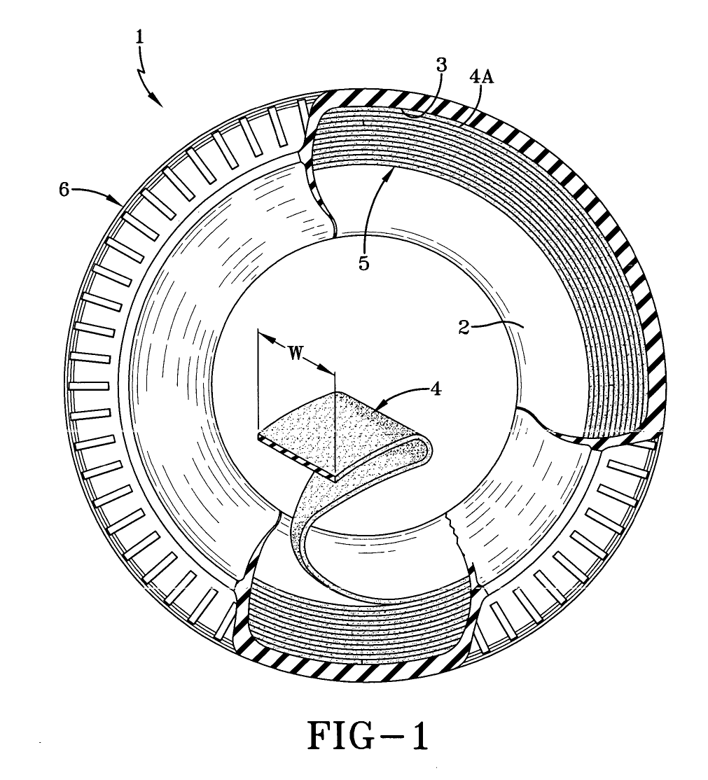

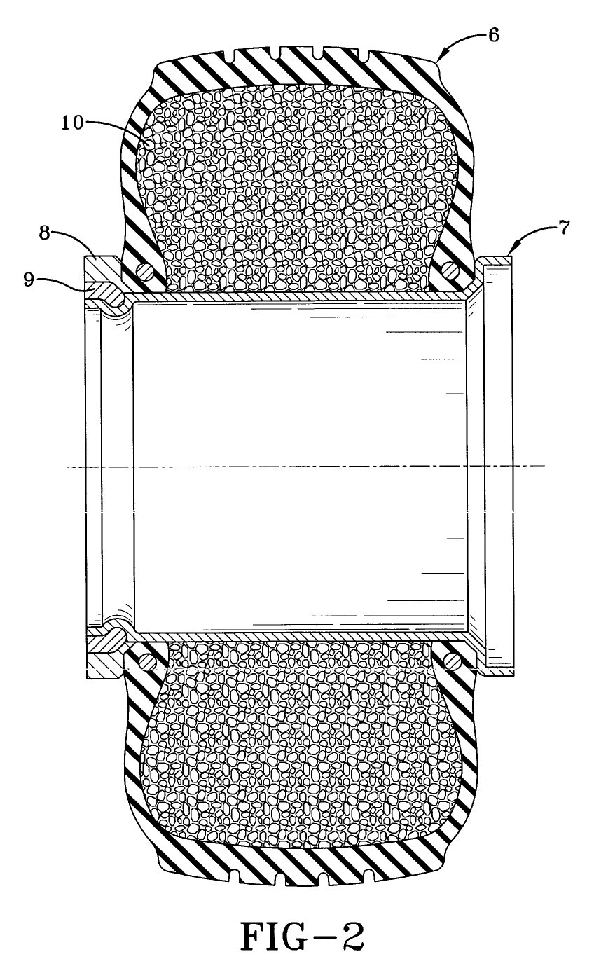

In FIG. 2 of a cross-sectional view showing a tire/insert/rim assembly as a closed cell filled, load bearing tire composed of a tire casing (6) mounted on a flanged rim (7) having a two piece mounting rings (8) and (9) to form an enclosed cavity with the closed cell foam formed as an insert (10) within and filling the tire cavity.

A significant aspect of the invention is the providing of a significantly shortened cure time, which results in reduced energy consumption, for formation of the closed cell rubber contained within the tire cavity, and thus a significantly reduced heat history for the cured rubber tire carcass, by a combination of organoperoxide with reduced half life temperature and blowing agent with a suitable decompositional heat activation temperature.

Therefore, it is also considered herein that a new, novel closed cell rubber precursor rubber composition is provided as a significant departure from past practice which provides a closed cell rubber composite within the pneumatic tire cavity which has similar laboratory determined physical properties and tire deflection properties as the heretofore dicumyl peroxide based organoperoxide/blowing agent combination.

The following example is provided for a further understanding of the invention and is not intended to be limiting. The parts and percentages are by weight unless otherwise specified.

### EXAMPLE I

### Preparation of Rubber Samples

Three samples of synthetic cis 1,4-polyisoprene rubber based rubber compositions, each individually containing a different organoperoxide curative are prepared and identified herein as Control Sample A and Samples B and C.

The purpose of this Example I is to show the decreased cure times based on Rheometer analytical results such, as for example, the T90 cure times. The T90 cure time is an indicator of the rubber composition cure (vulcanization) time which is an indication of the degree, or extent, of completeness of the peroxide reaction.

Control Sample A contained a conventional dicumyl peroxide (Di-Cup 40° C.), identified herein as organoperoxide No. 1 as the organoperoxide, having a one hour half life temperature of about 137° C.

Rubber Sample B used, for the organoperoxide, n-Butyl 4,4-Di(tert-butylperoxy) valerate, identified herein as organoperoxide No.2, having a one hour half life temperature of about 130° C., and obtained as Trigonox 17-40B from Akzo Nobel Chemical, Inc.

Rubber Sample C used, for the organoperioxide, 1,1′-di-(tert-butyl peroxy)-3,3,5-trimethyl cyclohexane, identified herein as organoperoxide No. 3, having a one hour half life temperature of about 117° C., and obtained as Linkcup™ TMCH40C from the Geo Specialty Chemical Company.

The rubber compositions were prepared by mixing the ingredients in an internal rubber mixer under high shear mixing conditions a preparatory, non-productive (NP) mixing stage for about five minutes to a temperature of about 125° C. to 160° C. whereupon the resulting rubber mixture was dumped from the internal rubber mixer, sheeted out from an open mill and allowed to cool to below 40° C.

Subsequently, the rubber mixture was mixed in a productive mixing stage (P), in an internal rubber mixer to which zinc oxide, sulfur curative and organoperoxide were added, for about three minutes to a temperature of about 80° C. to about 110° C. following which the mixture and dumped from the internal rubber mixer, sheeted out on an open mill and allowed to cool to below 40° C.

Formulations for Control Sample A and Samples B and C are illustrated in the following Table 1.

TABLE 1
(Rubber Sample Preparation Without Blowing Agent)

| | Samples | | |
|---|---|---|---|
| | Control | | |
| | A | B | C |
| Organoperoxide half life temperature (° C.) | 137 | 130 | 117 |
| Non-Productive Mixing Step | | | |
| Cis 1,4-polyisoprene rubber¹ | 100 | 100 | 100 |
| Carbon black (N660)² | 20 | 20 | 20 |
| Medium rubber processing oil³ | 25 | 25 | 25 |
| Productive Mixing Step | | | |
| Sulfur⁴ | 3 | 3 | 3 |
| Zinc oxide | 5 | 5 | 5 |
| Organoperoxide No. 1 (control)⁵ | 7 | 0 | 0 |
| Organoperoxide No. 2⁶ | 0 | 7 | 0 |
| Organoperoxide No. 3⁷ | 0 | 0 | 7 |

¹Synthetic cis 1,4-polyisoprene rubber as Natsyn 2200 ™ from The Goodyear Tire & Rubber Company
²N660 rubber reinforcing carbon black, an ASTM designation
³Naprex ™ 38 from ExxonMobil
⁴Rubber makers sulfur
⁵Dicumyl peroxide from Geo Specialty Chemicals
⁶n-Butyl 4,4-Di(tert-butylperoxy) valerate, reportedly having a one hour half life temperature of about 130° C., obtained as Trigonox 17-40B from Akzo Nobel Chemical, Inc.
⁷1,1-di-(tert-butyl peroxy) 3,3,5-trimethyl cyclohexane as Linkcup ™ TMCH40C from Geo Specialty Chemicals reportedly having one hour half life temperature of about 117° C.

Various physical properties are shown for the Control Sample A and Samples B and C in the following Table 2.

TABLE 2
Physical Properties of Rubber Samples

| | Samples | | |
|---|---|---|---|
| | Control | | |
| | A | B | C |
| Organoperoxide No. 1 (Control) | 7 | 0 | 0 |
| Organoperoxide No. 2 | 0 | 7 | 0 |
| Organoperoxide No. 3 | 0 | 0 | 7 |
| Organoperoxide one hour half life | 137 | 130 | 117 |
| temperature (° C.) | | | |
| Rheometer, (MDR)¹, 135° C. for | | | |
| 400 minutes | | | |
| Maximum torque (dNm) | 6.28 | 4.46 | 4.83 |
| Minimum torque (dNm) | 1.22 | 1.17 | 1.05 |
| Delta torque (dNm) | 5.06 | 3.29 | 3.78 |
| T1 minute | 8.89 | 7.88 | 2.55 |
| T25, minutes | 11.99 | 6.48 | 2.40 |
| T90, minutes | 148.47 | 47.97 | 18.52 |

¹Data obtained according to Moving Die Rheometer instrument, model MDR-2000 by Alpha Technologies, used for determining cure characteristics of elastomeric materials, such as for example torque, T90 etc.

The reported T1, T25 and T90 values are a measure of length of cure times in a sense of percentages of delta torque values. For example TI relates to a one percent rise (T25 and T90, to a 25 percent and 90 percent to rise, correspondingly) in the delta torque value.

From Table 2 it can be seen that use of organoperoxides with lower one hour half life temperature values resulted in significantly lower (shorter) cure times, particularly in the sense of the T90 value, namely that the T90 cure time for organoperoxide B (about 48 minutes) and for organoderoxide C (about 19 minutes) was significantly reduced in comparison to the use of Control organoperoxide (about 148 minutes).

While the reduced T90 cure time for Sample C was very significantly reduced (to a T90 of only about 19 minutes), it is believed that the significantly shorter cure time is within acceptable limits in sense of not prematurely curing the rubber sample before the contemplated blowing agent effectively forms the closed cellular configuration for the rubber composition.

It is considered herein that the T90 cure time for Sample C, using the organoperoxide No.3, namely the 1,1-di-(tert-butyl peroxy) 3,3,5-trimethyl cyclohexane as Linkcup™ TMCH40C, was within an acceptable time for the organoperoxide reaction. The next challenge is to determine if use of the 1,1-di-(tert-butyl peroxy) 3,3,5-trimethyl cyclohexane as the organoperoxide, with its considerably faster chemical reaction rate, can be satisfactorily be used with a blowing agent to prepare a closed cellular foam without the curing of the polyisoprene rubber based rubber composition being cured too quickly to restrict the foaming action of the blowing agent.

### EXAMPLE II

### Rubber Samples with Blowing Agent

Three samples of synthetic cis 1,4-polyisoprene rubber based rubber compositions, each individually containing a different organoperoxide curative were prepared and referred to herein as Control Sample D and Samples E and F.

The purpose of this Example II is to show the decreased cure times for the rubber compositions based upon observed physical properties in the sense of T90 cure times together with the effect of addition of a blowing agent to the rubber composition.

Control rubber Sample D contained conventional dicumyl peroxide (sometimes referred to as Di-Cup), identified as organoperoxide No. 1, as the organoperoxide, having a one hour half life temperature of about 137° C.

Rubber Sample E used, for the organoperoxide, 1,1′-di-(tert-butyl peroxy)-3,3,5-trimethyl cyclohexane identified as organoperoxide No. 4, having a one hour half life temperature of about 117° C., obtained as Trigonox 29-40B from Akzo Nobel Chemical, Inc.

Rubber Sample F also used, for the organoperoxide, 1,1′-di-(tert-butyl peroxy)-3,3,5-trimethyl cyclohexane, identified as organoperoxide No. 3 also having a one hour half life temperature of about 117° C., although obtained as Linkcup™ TMCH40C from the Geo Specialty Chemical Company used in the previous Example I.

The rubber compositions were prepared in a manner similar to Example I. The blowing agent was added by mixing with the rubber compositions on an open mill in a conventional mixing manner, namely between cylindrical steel rollers revolving in opposite directions with the rubber composition banding around one of the rollers with addition of a medium rubber processing oil and the blowing agent.

Formulations for Control Sample D and Samples E and F are illustrated in the following Table 3.

TABLE 3
(Rubber Sample Preparation Without Blowing Agent)

| | Samples | | |
|---|---|---|---|
| | Control | | |
| | D | E | F |
| Organoperoxide No. 1 (Control) | 5.9 | 0 | 0 |
| Organoperoxide No. 4 | 0 | 5.9 | 0 |
| Organoperoxide No. 3 | 0 | 0 | 5.9 |
| Organoperoxide one hour half life temperature | 137 | 117 | 117 |
| (° C.) | | | |
| Non-Productive Mixing Step | | | |
| Cis 1,4-polyisoprene rubber¹ | 100 | 100 | 100 |
| Carbon black (N660)² | 20 | 20 | 20 |
| Medium rubber processing oil³ | 25 | 25 | 25 |
| Productive Mixing Step | | | |
| Sulfur⁴ | 3 | 3 | 3 |
| Zinc oxide | 5 | 5 | 5 |
| Organoperoxide No. 1⁵ | 5.9 | 0 | 0 |
| Organoperoxide No. 4⁸ | 0 | 5.9 | 0 |
| Organoperoxide No. 3⁷ | 0 | 0 | 5.9 |

⁸1,1′-di-(tert-butyl peroxy)-3,3,5-trimethyl cyclohexane, having a one hour half life temperature of about 117° C., obtained as Trigonox 29-40B from Akzo Nobel Chemical, Inc.

The following Table 4 reports physical data for various physical properties of the Control Sample D and Samples E and F.

TABLE 4
(Physical Properties of Rubber Samples)

| | Samples | | |
|---|---|---|---|
| | Control | | |
| | D | E | F |
| Organoperoxide No. 1 (Control) | 5.9 | 0 | 0 |
| Organoperoxide No. 4 | 0 | 5.9 | 0 |
| Organoperoxide No. 3 | 0 | 0 | 5.9 |
| Organoperoxide half life temperature (° C.) | 137 | 117 | 117 |
| Rheometer, (MDR)¹, 135° C. for 400 | | | |
| minutes | | | |
| Maximum torque (dNm) | 5.55 | 4.63 | 4.64 |
| Minimum torque (dNm) | 1.05 | 1.02 | 0.97 |
| Delta torque (dNm) | 4.5 | 3.61 | 3.67 |
| T1 minute | 10.63 | 2.55 | 2.54 |
| T25, minutes | 12.5 | 2.33 | 2.36 |
| T90, minutes | 155.4 | 17.30 | 17.45 |
| Stress-strain (ATS)² | | | |
| ATS cure time at 135° C., (minutes) | 160 | 20 | 20 |
| 100% ring modulus (MPa) | 0.44 | 0.42 | 0.39 |
| 300% ring modulus (MPa) | 1.43 | 1.37 | 1.28 |
| Tensile strength (MPa) | 9.82 | 7.56 | 8.53 |
| Elongation at break (%) | 692 | 642 | 684 |
| Hardness (Shore A)³ | | | |
| 23° C. | 27.6 | 26.2 | 25.2 |
| 100° C. | 28.3 | 25.8 | 25.1 |
| Zwick Rebound (%)⁴ | | | |
| 23° C. | 69.5 | 67.8 | 67.5 |
| 100° C. | 75.2 | 69.0 | 68.6 |

¹Data obtained according to Moving Die Rheometer instrument, model MDR-2000 by Alpha Technologies, used for determining cure characteristics of elastomeric materials, such as for example torque, T90 etc.
²Data obtained according to Automated Testing System instrument by the Instron Corporation which incorporates six tests in one system. Such instrument may determine ultimate tensile, ultimate elongation, modulii, etc. Data reported in the Table is generated by running the ring tensile test station which is an Instron 4201 load frame.
³Shore A hardness according to ASTM D-1415
⁴Zwick rebound (ASTM 1054)

From Table 4 it can be seen that the T90 cure times are significantly reduced for Samples E (about 17 minutes) and F (about 17 minutes) as compared to the Control Sample D (about 155 minutes).

This is considered herein be significant because it is seen that the cure times for the rubber composition can be significantly reduced by use of the organoperoxides for the respective Samples, and therefore heat history of the respective tire.

From Table 4 it can also be seen that the reported physical properties of Sample E and Sample F are comparable to those of Control Sample D even though the T90 cure times are significantly reduced for Sample E and Sample F.

Accordingly, it is considered herein that the organoperoxides for Sample E and Sample F are candidates for use in the preparation of the closed cellular rubber composition for the tire cavity, with the aforesaid reduction in applied heat history for the precured tire itself, providing that such organoperoxides can be suitably used in combination with the blowing agent in a sense of not curing the rubber composition before the blowing agent effectively forms the closed cellular configuration.

Accordingly, thereafter the rubber mixtures (Control Sample D and Samples E and F) were individually mixed on an open mill (between cylindrical steel rolls with the rubber composition banding around one of the rolls) with addition of a blowing agent and a medium rubber processing oil as a processing aid as illustrated in the following Table 5.

TABLE 5
(Addition of Blowing Agent to Rubber Sample Composition)

| | Samples | | |
|---|---|---|---|
| | Control | | |
| | D | E | F |
| Organoperoxide No. 1 (Control) | 5.9 | 0 | 0 |
| Organoperoxide No. 4 | 0 | 5.9 | 0 |
| Organoperoxide No. 3 | 0 | 0 | 5.9 |
| Organoperoxide one hour half life | 137 | 117 | 117 |
| temperature (° C.) | | | |
| Mill, Open Roll, Mixing Step | | | |
| Medium rubber processing oil³ | 1.61 | 1.61 | 1.61 |
| Blowing agent¹⁰ | 4.83 | 4.83 | 4.83 |

³Naprex ™ 38 from ExxonMobil
¹⁰Composite of benzene sulfonyl hydrazide as Unicell-BSHTM from Dong jin Chem Ind Co. Ltd. and oil composed of 75 weight percent of the benzene sulfonyl hydrazide blowing agent and 25 percent oil and so is 75 percent active as said blowing agent and which is reported in the Table in terms of the total composite.

Various physical properties of Control Sample D and Samples E and F with the added blowing agent are reported in the following Table 6.

TABLE 6
(Physical Properties of Rubber Samples With Blowing Agent)

| | Samples | | |
|---|---|---|---|
| | Control | | |
| | D | E | F |
| Organoperoxide No. 1 (control) | 5.9 | 0 | 0 |
| Organoperoxide No. 4 | 0 | 5.9 | 0 |
| Organoperoxide No. 3 | 0 | 0 | 5.9 |
| Organoperoxide one hour half life | 137 | 117 | 117 |
| temperature (° C.) | | | |
| Rheometer, (MDR)¹, 135° C. for 400 | | | |
| minutes | | | |
| Maximum torque (dNm) | 6.11 | 5.71 | 5.67 |
| Minimum torque (dNm) | 0.65 | 0.73 | 0.72 |
| Delta torque (dNm) | 5.46 | 4.98 | 4.95 |
| T1 minute | 9.95 | 1.98 | 2.19 |
| T25, minutes | 14.92 | 2.43 | 2.71 |
| T90, minutes | 183.52 | 59.62 | 91.97 |
| Stress-strain (ATS)² | | | |
| ATS cure time at 135° C., (minutes) | 160 | 160 | 160 |
| 100% ring modulus (MPa) | 0.61 | 0.61 | 0.66 |
| 300% ring modulus (MPa) | 2.02 | 2.17 | 2.40 |
| Tensile strength (MPa) | 10.06 | 9.31 | 14.7 |
| Elongation at break (%) | 625 | 595 | 681 |
| Hardness (Shore A)³ | | | |
| 23° C. | 32.7 | 31.6 | 33.7 |
| 100° C. | 33.3 | 32.2 | 34.4 |
| Zwick Rebound (%) | | | |
| 23° C. | 71.9 | 72.5 | 71.2 |
| 100° C. | 77.2 | 79 | 76.8 |
| Specific Gravity (SpGr) | 1.014 | 0.985 | 1.021 |
| RPA⁴ (100° C., 0.833 Hertz, | | | |
| 15% Strain) | | | |
| Storage modulus (G′), uncured, | 0.0488 | 0.0502 | 0.0509 |
| (MPa) | | | |

⁴Data obtained according to Rubber Process Analyzer as RPA 2000 ™ instrument by Alpha Technologies, formerly the Flexsys Company and formerly the Monsanto Company. References to an RPA-2000 instrument may be found in the following publications: H. A. Palowski, et al, Rubber World, June 1992 and January 1997, as well as Rubber & Plastics News, April 26 and May 10, 1993.

From Table 6 it can be seen that the T90 cure times are significantly reduced for Sample E (about 60 minutes) and Sample F (about 92 minutes) as compared to Control Sample D (about 184 minutes) with the blowing agent addition.

This is considered herein be significant because it is again shown that the cure times to achieve the peroxide decomposition can be significantly reduced by use of the respective organoperoxides for Sample E and Sample F, together with obtaining comparable physical properties, as compared to Control Sample D and thus a significant reduction in the heat history for the respective cured tires, particularly including the tire tread and carcass cured rubber compositions.

Further, insofar as the use of the respective organoperoxides in combination with the blowing agent is concerned, it is seen from Table 6 that faster cure times for the closed cell bubble formation for production of a closed cell cellular rubber composition were obtained.

### EXAMPLE III

### Rubber Samples Without Blowing Agent

Two samples of synthetic cis 1,4-polyisoprene rubber based rubber compositions with an organoperoxide curative, were prepared and identified herein as Control Sample G and rubber Sample H.

A purpose of this Example III is to compare the use of dicumyl peroxide as the organoperoxide (Control Sample G) with the use of, 1,1′-di-(tert-butyl peroxy)-3,3,5-trimethyl cyclohexane as the organoperoxide (rubber Sample H).

Control Sample G contained dicumyl peroxide, identified herein as organoperoxide No. 1 (the same organoperoxide No 1 used in Example 1), having a one hour half life temperature of about 137° C.

Rubber Sample H contained, for the organoperoxide, 1,1′-di-(tert-butyl peroxy)-3,3,5-trimethyl cyclohexane, identified herein as organoperoxide No. 3 (the same organoperoxide used as organoperoxide No. 3 in Example I), having a one hour half life temperature of about 117° C., obtained as Linkcup™ TMCH,40C from Geo Specialty Chemical Company.

The rubber compositions were prepared in the manner of Example I.

Formulations for Control Sample G and Sample H are illustrated in the following Table 7.

TABLE 7
(Rubber Composition Samples Without Blowing Agent)

| | Samples | |
|---|---|---|
| | Control | |
| | G | H |
| Organoperoxide one hour half life temperature (° C.) | 137 | 117 |
| Non-Productive Mixing Step | | |
| Cis 1,4-polyisoprene rubber1 | 100 | 100 |
| Carbon black (N660)² | 20 | 20 |
| Medium rubber processing oil³ | 25 | 25 |
| Productive Mixing Step | | |
| Sulfur⁴ | 3 | 3 |
| Zinc oxide | 5 | 5 |
| Organoperoxide No. 1 | 7 | 0 |
| Organoperoxide No. 3 | 0 | 7 |

The following Table 8 reports physical data for various physical properties of Control Sample G and Sample H.

TABLE 8
(Physical Properties of Rubber Samples)

| | Samples | |
|---|---|---|
| | Control | |
| | G | H |
| Organoperoxide No. 1 (Control) | 7 | 0 |
| Organoperoxide No. 3 | 0 | 7 |
| Organoperoxide half life temperature (° C.) | 137 | 117 |
| Rheometer, (MDR)¹, 135° C. for 400 minutes | | |
| Maximum torque (dNm) | 5.97 | 5.12 |
| Minimum torque (dNm) | 1.11 | 1.05 |
| Delta torque (dNm) | 4.86 | 4.07 |
| T1 minute | 8.68 | 2.24 |
| T25, minutes | 11.16 | 2.28 |
| T90, minutes | 136.7 | 18.10 |
| Stress-strain (ATS)² | | |
| ATS cure time at 135° C., (minutes) | 160 | 25 |
| 100% ring modulus (MPa) | 0.60 | 0.55 |
| 300% ring modulus (MPa) | 2.32 | 2.06 |
| Tensile strength (MPa) | 11.82 | 14.13 |
| Elongation at break (%) | 620 | 690 |
| Hardness (Shore A)³ | | |
| 23° C. | 33.8 | 31.7 |
| 100° C. | 34.6 | 32.1 |
| Zwick Rebound (%) | | |
| 23° C. | 74.8 | 72.4 |
| 100° C. | 76.7 | 76.3 |
| Specific gravity (Sp Gr) | 1.021 | 1.017 |
| RPA | | |
| Uncured G′(100° C., 0.83 Hertz, 15% strain) | 0.0879 | 0.0804 |

From Table 8 it can be seen that a significantly reduced T90 cure time is obtained for rubber Sample H (about 18 minutes) as compared to Control Sample G (about 138 minutes) as well as comparable reported physical properties.

This is considered herein to be significant in that is additionally illustrates significantly reduced T90 cure times together with comparable reported physical properties when using the 1,1′-di-(tert-butyl peroxy)-3,3,5-trimethyl cyclohexane as the organoperoxide obtained as Linkcup™ TMCH40C from Geo Specialty Chemical Company.

### EXAMPLE IV

### Rubber Samples Without Blowing Agent

Four samples of rubber compositions containing both synthetic cis 1,4-polyisoprene rubber and cis 1,4-polybutadiene rubber containing an organoperoxide curative are prepared and identified herein as Control Sample I and Samples J, K and L.

A purpose of this Example IV is to endeavor to optimize physical properties, reduce T90 cure times in combination with reducing cost for the respective rubber compositions, namely Samples J, K and L.

Control Sample I contained dicumyl peroxide, identified herein as organoperoxide No. 1, (the same organoperoxide No 1 used in Example 1), having a one hour half life temperature of about 137° C.

Rubber Samples J, K and L contained, for the organoperoxide, 1,1′-di-(tert-butyl peroxy)-3,3,5-trimethyl cyclohexane, identified herein as organoperoxide No. 3 (the same organoperoxide used as organoperoxide No. 3 in Example 1), having a one hour half life temperature of about 117° C., obtained as Linkcup™ TMCH40C from Geo Specialty Chemical Company.

Samples K and L also contained a finely ground coal dust as Austin Black 325 from Coal Fillers, Inc.

The rubber compositions were prepared in the manner of Example 1.

Formulations for Control Sample I and Samples J, K and L are illustrated in the following Table 9.

TABLE 9
(Rubber Composition Samples Without Blowing Agent)

| | Samples | | | |
|---|---|---|---|---|
| | Control | | | |
| | I | J | K | L |
| Organoperoxide one hour half life | 137 | 117 | 117 | 117 |
| temperature (° C.) | | | | |
| Non-Productive Mixing Step | | | | |
| Cis 1,4-polyisoprene rubber¹ | 100 | 50 | 50 | 50 |
| Cis 1,4-polybutadiene rubber^{1A} | 0 | 50 | 50 | 50 |
| Carbon black (N660)² | 20 | 15 | 15 | 15 |
| Coal dust^{2A} | 0 | 35 | 35 | 35 |
| Medium rubber processing oil³ | 25 | 35 | 35 | 35 |
| Productive Mixing Step | | | | |
| Sulfur⁴ | 3 | 3 | 3 | 3 |
| Zinc oxide | 5 | 5 | 5 | 5 |
| Organoperoxide No. 1 | 7 | 0 | 0 | 0 |
| Organoperoxide No. 3 | 0 | 7 | 5 | 3.5 |

^{1A}cis 1,4-polybutadiene rubber as Budene ™ 1207 from The Goodyear Tire & Rubber Company
^{2A}Coal dust as Austin Black from Coal Fillers, Inc.

The following Table 10 reports physical data for various physical properties of Control Sample I and Samples J, K and L.

TABLE 10
(Physical Properties of Rubber Samples)

| | Samples | | | |
|---|---|---|---|---|
| | Control | | | |
| | I | J | K | L |
| Organoperoxide No. 1 | 7 | 0 | 0 | 0 |
| (Control) | | | | |
| Organoperoxide No. 3 | 0 | 7 | 5 | 3.5 |
| Coal dust | 0 | 35 | 35 | 35 |
| Organoperoxide one hour half | 137 | 117 | 117 | 117 |
| life temperature (° C.) | | | | |
| Rheometer, (MDR)¹, | | | | |
| 135° C. for 400 minutes | | | | |
| Maximum torque (dNm) | 6.01 | 6.98 | 5.93 | 4.98 |
| Minimum torque (dNm) | 1.13 | 1.27 | 1.15 | 1.15 |
| Delta torque (dNm) | 4.88 | 5.71 | 4.78 | 3.83 |
| T1 minute | 8.96 | 1.81 | 2.46 | 3.28 |
| T25, minutes | 11.58 | 2.43 | 2.86 | 3.15 |
| T90, minutes | 143 | 17.43 | 17.08 | 16.12 |
| Stress-strain (ATS)² | | | | |
| ATS cure time at 135° C., | 160 | 25 | 25 | 25 |
| (minutes) | | | | |
| 100% ring modulus (MPa) | 0.57 | 0.73 | 0.61 | 0.5 |
| 300% ring modulus (MPa) | 2.2 | 2.69 | 2.20 | 1.73 |
| Tensile strength (MPa) | 11.67 | 8.07 | 6.95 | 6.4 |
| Elongation at break (%) | 631 | 653 | 668 | 706 |
| Hardness (Shore A)³ | | | | |
| 23° C. | 32.1 | 37.9 | 34.5 | 31.0 |
| 100° C. | 33.5 | 38.2 | 34.6 | 31.2 |
| Zwick Rebound (%) | | | | |
| 23° C. | 73.7 | 66.9 | 63.4 | 58.8 |
| 100° C. | 75.9 | 67.7 | 64.4 | 59.3 |
| RPA | | | | |
| Uncured G′(100° C., | 0.0886 | 0.091 | 0.085 | 0.0854 |
| 0.83 Hertz, 15% strain) | | | | |

From Table 10 it can be seen that significant T90 cure times were obtained for rubber Samples J, K and L were obtained, as compared to Control rubber Sample 1, together with comparable reported physical properties which further illustrates that significantly reduced cure times for the rubber composition with comparable physical properties can be obtained with the addition of a coal dust to also reduce heat history for the cured tire carcass.

### EXAMPLE V

### Tire Deflection Data

Cured torroidal rubber tires of size 12.00R20 were prepared to which an insert of layers of strip(s) of a rubber composition as precursor to a closed cell rubber composition which contained a combination of an organoperoxide and blowing agent were applied within their individual cavities to fill approximately 75 percent of their cavity volumes.

The tires containing the closed cell rubber precursor rubber inserts were individually placed in an autoclave and the closed cell rubber precursor compositions were allowed to cure and form a closed cell rubber insert within the respective tire cavities at a temperature extending from an initial room temperature (e.g. about 23° C.) up to an autoclave temperature of about 135° C. for various periods of time, depending primarily upon the selection of organoperoxide.

In particular, the tires which contained the closed cell rubber precursor insert within the their cavities were heated for various periods of time in the autoclave at the indicated temperature rise to cause the blowing agent to decompose and create the closed cellular rubber structure within the tire cavity while also causing the organoperoxide to decompose and form the peroxide free radicals to, in turn, cause the closed cellular rubber structure to cure within the tire cavity.

The Tires are identified herein as Control Tire A and Tires C-1, C-2, C-3, C-4 and K.

Control Tire A contained a closed cell rubber composition prepared with conventional dicumyl peroxide as the organoperoxide, (previously identified in these Examples as organoperoxide No. 1 having a one hour half life temperature of about 137° C.) similar to the rubber composition as Control Sample A of Example I herein in which 6.48 phr of a blowing agent is blended with the rubber composition as the aforesaid benzene sulfonyl hydrazide composite of sulfonyl hydrazide and oil.

Tires C-1, C-2, C-3 and C-4 contained a closed cell rubber composition prepared with 1,1′-di-(tert-butyl peroxy)-3.3,5-trimethyl cyclohexane as the organoperoxide, (previously identified herein as organoperoxide No. 3, having a significantly reduced one hour half life temperature of about 117° C., and obtained as Linkcup™ TMCH40C) similar to the rubber composition as Sample C of Example I herein in which 6.48 phr of a blowing agent is blended with the rubber composition as the aforesaid benzene sulfonyl hydrazide composite of benzene sulfonyl hydrazide and oil.

Tire K contained a closed cell rubber composition prepared also with the 1,1′-di-(tert-butyl peroxy)-3,3,5-trimethyl cyclohexane as the organoperoxide, (previously identified in these Examples as organoperoxide No.3) similar to the rubber composition as Sample K of Example IV herein in which 7.8 phr of a blowing agent is blended with the rubber composition as the aforesaid benzene sulfonyl hydrazide composite of sulfonyl hydrazide and oil.

The rubber composition was therefore composed of a combination of cis 1,4-polyisoprene rubber and cis 1,4-butadiene rubber and the carbon black filler also contained coal dust. The blowing agent was used in amount of 7.8 phr of the aforesaid composite instead of 6.48 phr because of the increased amount of carbon black filler contained in the rubber composition.

The rubber insert-containing tires were mounted on rims to close the tire cavity prior to inserting the tires into the autoclaves so that a tire/rim assembly is prepared which contains the closed cellular rubber insert within the tire cavity.

The closed cell rubber foam-containing tire/rim assemblies were individually submitted to a load deflection test (after allowing the tire assemblies cool, to room temperature, or about 23° C., for a period of time of about twice the time of the placement of the tire/rim assembly in the autoclave) to determine the individual tire deflections according to the formula:

$$Percent Deflection = \frac{UD - LD}{UD - FD} ⨯ 100 \%$$

Where: UD=diameter of the tire
LF=diameter of the loaded tire
FD=flange diameter=rim diameter+(2×flange height)

The results of the load deflection tests are shown in the following Table 11.

TABLE 11
(Deflection Test Data

| | Autoclave | Percent of | Percent of |
|---|---|---|---|
| | Cure | Control | Tire |
| Tires | Time, Hrs | Cure Time | Deflection¹ |
| Control Tire A | 13.5 | 100 | 22.02 |
| (organoperoxide No. 1) | | | |
| Tire C-1 | 13.5 | 100 | 20.04 |
| (organoperoxide No. 3) | | | |
| Tire C-2 | 12 | 89 | 20.27 |
| (organoperoxide No. 3) | | | |
| Tire C-3 | 10 | 74 | 20.14 |
| (organoperoxide No. 3) | | | |
| Tire C-4 | 8 | 59 | 21.21 |
| (organoperoxide No. 3) | | | |
| Tire K | 12 | 89 | 18.55 |
| (organoperoxide No. 3) | | | |

¹The comparative tire deflection tests were conducted at room temperature (e.g. about 23° C.) by placing the indicated tire on a first metal plate and placing a second metal plate on top of the tire with the first and second plates in parallel relationship to each other and then applying a load in a sense of pressure (force) in an amount of about 16,100 pounds (71,645 Newtons) force/load applied to the top plate and measuring the associated deflection.

From Table 11 it can be seen that significantly reduced cure times in the autoclave can successfully be used while maintaining substantially equivalent percent deflections for the tire.

This is considered herein to be significant because reduced cure times enable lower utility costs (electricity and steam heat application to the autoclave), reduced heat application to the tire carcass and increased autoclave output (rate of production of foam filled tires).

The results reported in Table 11 are also considered herein to be significant it verifies that a more efficient usage of the organoperoxide can occur having the significantly reduced one hour half life temperature (117° C. instead of the 137° C.) because for the same or similar cure time in the autoclave, more of the organoperoxide is used up and therefore not remaining in the closed cellular rubber composition to later decompose to form free radical(s).

While certain representative embodiments and details have been shown for the purpose of illustrating the invention, it will be apparent to those skilled in this art that various changes and modifications may be made therein without departing from the spirit or scope of the invention.

What is claimed is:

1. A method of producing a tire which contains a closed cellular rubber within its cavity comprises heating an assembly comprised of a vulcanized tire and an uncured, unfoamed rubber insert contained within its tire cavity to cause said rubber insert to both cure and expand to form a closed cell containing rubber within the tire cavity:
wherein said uncured, unfoamed, rubber insert is comprised of:
(A) at least one conjugated diene-based elastomer comprised of, based upon parts by weight per hundred parts by weight rubber (phr):
(1) cis 1,4-polyisoprene rubber, or
(2) about 25 to about 100 phr of cis 1,4-polyisoprene rubber, and from zero to about 75 phr of at least one additional conjugated diene-based rubber;
(B) heat activatable, free radical generating, organoperoxide having a one hour half life temperature in a range of from about 70° C. to about 150° C., and
(C) heat activatable, gas generating, blowing agent having a heat activatable temperature within a range of from about 80° C. to about 150° C.

2. The method of claim 1 wherein said uncured, unfoamed rubber insert contains from about 10 to about 60 phr of carbon black, wherein said carbon black is.
(A) comprised of rubber reinforcing carbon black, or
(B) comprised of a combination of rubber reinforcing carbon black and coal dust.

3. The method of claim 1 wherein said organoperoxide is comprised of n-butyl 4,4-di(tert-butylperoxy) valerate or 1,1′-di-(tert-butyl peroxy)-3,3,5-trimethyl cyclohexane or their mixtures.

4. The method of claim 1 wherein said blowing agent is comprised of benzene sulfonyl hydrazide.

5. The method of claim 3 wherein said blowing agent is comprised of benzene sulfonyl hydrazide.

6. The method of claim 1 wherein said uncured rubber insert within said tire cavity is composed of a plurality of layers of the uncured rubber composition as a foamable foam rubber precursor within the tire cavity of the pre-vulcanized rubber tire.

7. The method of claim 1 wherein the uncured rubber insert is composed of individual strips of the uncured rubber composition and/or a spirally wound strip of the uncured rubber composition of a combination thereof.

8. The method of claim 1 wherein said method includes a method of inflating a tire with foamable rubber material which comprises:
(A) layering at least one pre-formed strip of said unfoamed, foamable rubber in an abutting annular relation within the cavity of a said previously cured tire to thereby form a laminated annular insert which, when foamed, expands within the tire cavity and produces a tire pressure within the tire cavity;
(B) mounting the tire with said laminated annular insert therein on a rigid rim to form a tire/insert/rim assembly thereof, and
(C) heating the said tire/insert/rim assembly to a temperature in a range of from about 100° C. to about 150° C. to foam and cure the foamable material therein to form a closed cell foamed rubber insert under pressure within the tire/rim cavity.

9. The method of claim 1 wherein the thickness of each uncured rubber strip for said insert is in a range of from about 0.508 cm to about 2.54 cm.

10. The method of claim 1 wherein said method includes a step of compacting the layers of unfoamed, foamable, rubber radially against each other and the inner crown of the tire prior to mounting the tire on a rim.

11. The method of claim 10 wherein said step of compacting includes mounting an inflatable bladder adjacent to one of said layered strips of unfoamed, foamed rubber and inflating the inflatable bladder to compressively engage said layer.

12. The method of claim 8 wherein said layering includes the step of placing the first strip of unfoamed, foamable rubber against the inner crown of the tire.

13. The method of claim 8 which includes swabbing the inner crown of the tire with an adhesive prior to placing the first strip of unfoamed, foamable rubber thereagainst.

14. A cured rubber tire/rigid rim assembly, wherein said cured rubber is of an open toroidal shape, having a cavity defined by toroidal rubber tire and said rigid rim, wherein said cavity contains an unfoamed rubber insert therein, wherein said uncured, unfoamed, rubber insert is comprised of:
(A) at least one conjugated diene-based elastomer comprised of, based upon parts by weight per hundred parts by weight rubber (phr):
(1) cis 1,4-polyisoprene rubber, or
(2) about 25 to about 100 phr of cis 1,4-polyisoprene rubber, and from zero to about 75 phr of at least one additional conjugated diene-based rubber;
(B) heat activatable, free radical generating, organoperoxide having a one hour half life temperature in a range of from about 70° C. to about 150° C., and
(C) heat activatable, gas generating, blowing agent having a heat activatable temperature within a range of from about 80° C. to about 150° C.

15. The cured rubber tire/rigid rim assembly of claim 14 wherein said uncured, unfoamed, rubber insert contains from about 10 to about 60 phr of carbon black, wherein said carbon black is:
(A) comprised of rubber reinforcing carbon black, or
(B) comprised of a combination of rubber reinforcing carbon black and coal dust.

16. The cured rubber tire/rigid rim assembly of claim 14 wherein, for said uncured, unfoamed, rubber insert, said organoperoxide is comprised of n-butyl 4,4-di(tert-butylperoxy) valerate or 1,1′-di-(tert-butyl peroxy)-3,3,5-trimethyl cyclohexane or their mixtures.

17. The cured rubber tire/rigid rim assembly of claim 14, wherein for said uncured, unfoamed, rubber insert, said blowing agent is comprised of benzene sulfonyl hydrazide.

18. The cured rubber tire/rigid rim assembly of claim 16, wherein for said uncured, unfoamed, rubber insert, said blowing agent is comprised of benzene sulfonyl hydrazide.

19. A cured rubber tire/rigid rim assembly, wherein said cured rubber is of an open toroidal shape, having a cavity defined by toroidal rubber tire and said rigid rim, wherein said cavity contains a closed cellular foamed rubber insert therein prepared by curing and foaming said uncured, unfoamed, rubber insert contained within said cavity in said cured rubber tire/rigid rim assembly of claim 14.

20. The cured rubber tire/rigid rim assembly of claim 18 wherein said closed cellular foamed rubber insert contains from about 10 to about 60 phr of carbon black, wherein said carbon black is:
(A) comprised of rubber reinforcing carbon black, or
(B) comprised of a combination of rubber reinforcing carbon black and coal dust.
